(19) United States
(12) Patent Application Publication
(10) Pub. No.: US 2012/0319367 A1
(43) Pub. Date: Dec. 20, 2012

(54) Shopping Cart With Passenger Seating

(76) Inventor: Mary Hermosillo, Merced, CA (US)

(21) Appl. No.: 13/160,926

(22) Filed: Jun. 15, 2011

(51) Int. Cl. B62D 39/00

(52) U.S. Cl. 280/33.993

(57) ABSTRACT

A shopping cart with passenger seating comprising a body; a base extending from a bottom portion of the body, where the base and the body create an L-shape; a child seat at a top portion of the body; a handle at the top portion of the body; a passenger seat positioned above the base; a storage area beneath the passenger seat, where the storage area includes a storage surface atop the base, where the storage surface serves as a step for a seated user to mount the passenger seat; a container upon the storage surface, where the container allows a user to store their items while shopping; and a set of wheels fastened beneath the base, where the set of wheels enable the shopping cart with passenger seating to easily move from one place to another.

### BACKGROUND OF THE INVENTION

1. Field of the Invention

The present invention relates to a shopping cart with seating to accommodate seating for both a child and an additional passenger.

2. Description of Related Art

Shopping carts are staple items available at all grocery stores and many department stores to assists shoppers with holding their items while they continue shopping. Most shopping carts include child seats to allow a small child or toddler to rest while the adult maneuvers the cart from location to location. For some individuals shopping is difficult because they are in a wheelchair or have limited mobility. For users with limited mobility motorized carts are often helpful. The motorized carts enable the person to drive themselves around the store, and place their goods in a basket attached to the front of the cart. Unfortunately, wheelchair users have difficulties using both conventional shopping carts and motorized carts without assistance.

Recently, some developments and modifications have been made with shopping carts and wheelchairs to better assist wheelchair users. For example, U.S. Pat. No. 4,403,786 by George Ulics discloses a wheelchair shopping basket wherein a wheelchair includes a front basket to provide a container for the user to store their grocery items while they are shopping. The basket attaches to the user's standard wheelchair and may be removed when not in use. Alternatively, U.S. Pat. No. 4,305,601 by Kermit Berge discloses a shopping cart for the handicapped wherein a wheeled frame mounts a basket to a front portion of the wheelchair. The wheeled frame supports itself so that the user's chair does not have to support the additional weight.

While these adaptable baskets do assist some wheelchair users, many others are unable to shop due to their lack of independent physical mobility. On the current market, a shopping cart that assists a caretaker when shopping with a physically disabled adult does not exist. Therefore it would be desirable in the art to provide a shopping cart with seats to accommodate an adult passenger. It would also be beneficial in the art to provide a cart with both adult and child seating.

### SUMMARY OF THE INVENTION

In view of the foregoing disadvantages inherent in the prior art, the general purpose of the present invention is to provide a shopping cart with passenger seating, configured to include all of the advantages of the prior art, and to overcome the drawbacks inherent therein.

Accordingly, an object of the present invention is to provide a shopping cart that includes seating for both a child and an adult passenger thereby assisting caretakers when shopping with individuals with limited mobility.

Another object of the present invention is to provide a shopping cart with passenger seating wherein a storage area is positioned beneath the adult seat to allow the user to place and store their items while shopping.

To achieve the above objects, in an aspect of the present invention, a shopping cart with passenger seating is disclosed comprising a body; a base extending from a bottom portion of the body, where the base and the body create an L-shape; a child seat at a top portion of the body; a handle at the top portion of the body; a passenger seat positioned above the base; a storage surface atop the base, where the storage surface serves as a step for a seated user to mount the passenger seat; a container upon the storage surface, where the container allows a user to store their items while shopping; and a set of wheels fastened beneath the base, where the set of wheels enable the shopping cart with passenger seating to easily move from one place to another.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings in which:

FIG. 1 depicts a perspective view of a shopping cart with passenger seating in accordance with an exemplary embodiment of the present invention.

### DETAILED DESCRIPTION OF THE DRAWINGS

The present invention relates to a shopping cart with seating to accommodate seating for both a child and an additional passenger. The present invention provides a shopping cart with passenger seating to combine the benefits of a shopping cart with the additional feature of a wheelchair. The shopping cart with passenger seating includes a child seat at a top portion of the body to receive a child or toddler. On a front portion of the shopping cart is a passenger seat to enable an additional passenger to rest. The passenger seat includes cushions, armrests and a seatbelt to secure the passenger in place. This is especially useful for those passengers with limited mobility or physical disabilities to ensure that they do not fall from the passenger seat. Beneath the passenger seat is a storage area where the user may place their grocery or shopping items. The shopping cart with passenger seating enables a user to manually maneuver the shopping cart through the store with the added features of providing seating for their loved ones who are unable to shop without assistance.

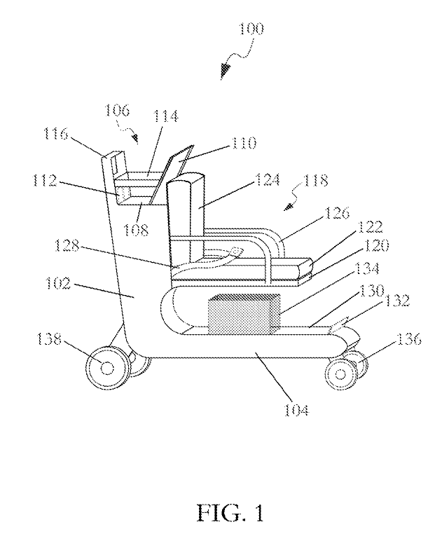

Tuning now descriptively to the drawings, referring to FIG. 1, a perspective view of a shopping cart with passenger seating (100) is shown in accordance with an exemplary embodiment of the present invention. The shopping cart with passenger seating (100) includes a body (102) as the structural backing and frame support for the shopping cart. The body (102) includes a base (104) that rests horizontally along the bottom portion of the body (102). The base (104) extends forward from the body (102), at a rear portion of the shopping cart with passenger seating (100), to the front portion. The body (102) and the base (104) essentially create an L-shaped structure to comprise the main portions of the shopping cart with passenger seating (100). The body (102) and the lower portion (104) may be made from a plastic, metal, or metallic mesh material for durable yet lightweight construction.

Positioned at a top portion of the housing (102) is a child seat (106). The child seat (106) includes a seat (108) to receive the bottom of a child user. Rising from the child seat (106) at the side of the seat (108) positioned above where the body (102) meets the base (104) may be a backing (110). The backing (110) may be a backrest or angled support for the child user's back thereby allowing them to lean back while sitting in the child seat (106). At an opposite portion of the seat (108) from where the backing (110) rises are a pair of leg holes (112). The pair of leg holes (112) receives the child user's legs while they are seated. Against the lateral sides of the child seat (106) are a pair of side guards (114) to contain the child user and ensure that they do not fall from the body (102). The pair of side guards (114) may be a rail, bar or wall to secure the child user within the child seat (106). While seated, the child user faces the user standing behind the body (102). Attached to the top portion of the body (102), above the pair of leg holes (112), is a handle (116). The handle (116) is where the user places their hands to steer and maneuver the shopping cart with passenger seating (100). The handle (116) may be covered with a soft grip material for additional comfort against the user's hands. The pair of leg holes (112) and the handle (116) may be a continuation or extension of the body (102) for structural stability.

Positioned at the front portion of the shopping cart with passenger seating (100), above the bottom support (104), is a passenger seat (118). The passenger seat (118) allows a seated user to rest while the user is shopping. The seated user may be a person with disabilities who cannot walk or cannot support themselves for extended periods of time. The passenger seat (118) includes a seat support (120) extending from the body (102) parallel to the base (104). The seat support (120) may be made from a strong metallic material to provide sufficient support beneath the seated user to ensure that the seat support (120) does not sag or bend during use. Additionally a pair of bars (not shown) may connect the seat support (120) to the base (104) to prevent bending and to add strength to the seat support (120).

Upon the seat support (120) may be a seat cushion (122) for a padded surface below where the seated user is sitting. Against a back portion of the passenger seat (118), extending up from where the seat cushion (122) meets the body (102), may be a back cushion (124). The back cushion (124) pads the seated user's back while resting on the passenger seat (118). The seat cushion (122) and the back cushion (124) may be removable and may be secured to the seat support (120) and the body (102) with Velcro, snaps, clips and the like. The seat cushion (122) and the back cushion (124) may be covered in a flexible plastic material or a durable cloth material for extended use.

The passenger seat (118) may include a seatbelt (128) fastened to the seat support (120) to secure the seated user upon the seat cushion (122). Also, the passenger seat (118) may have a pair armrests (126) attached to the lateral sides of the seat support (120). The armrests (126) prevent the seated user from leaning too far to the sides thereby preventing them from falling off the passenger seat (118). The armrests (126) may be padded for additional comfort.

Beneath the passenger seat (118), above the base (104), is a storage area. The storage area includes a storage surface atop the base (104). The storage surface (130) may extend along the entire top portion of the base (104). The storage surface (130) may also serve as a step for the seated user to utilize when mounting the passenger seat (118). At a front portion of the base (104) may be a foot rest (132) for the seated user to place their feet. Resting upon the storage surface (130) may be a container (134). The container (134) may receive the user's grocery items while they are shopping. The container (134) may be a wire or plastic basket, a plastic box or a net bag to contain the items on the storage surface (130). The storage surface (130) may receive one or more containers (134). Alternatively, the container (134) may encompass the entire storage area.

Fastened beneath the base (104) are a set of wheels (136, 138). Beneath a front end of the base (104) are a pair of front wheels (136) and beneath a back end of the base (104) are a pair a rear wheels (138). The pair of front wheels (136) may be smaller than the pair of rear wheels (138) to assist the user when steering and maneuvering the shopping cart with passenger seating (100).

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A shopping cart with passenger seating comprising:
a body, where the body provides structural support for the shopping cart;
a base extending from a bottom portion of the body, where the base and the body create an L-shape;
a child seat at a top portion of the body, where the child seat comprises:
a seat to receive a child;
a pair of leg holes at a top portion of the body, where the pair of leg holes receive the child's legs; and
a pair of side guards at the lateral portions of the seat, where the pair of side guards contain the child on the child seat;
a handle at the top portion of the body above the pair of leg holes;
a passenger seat positioned above the base, where the passenger seat comprises:
a seat support extending from the body, positioned parallel to the base;
a pair of armrests on the lateral portions of the seat support; and
a seatbelt attached to the seat support to secure a seated user in place;
a storage area beneath the passenger seat, where the storage area includes:
a storage surface atop the base, where the storage surface serves as a step for the seated user to mount the passenger seat; and
a container upon the storage surface, where the container allows a user to store their items while shopping; and
a set of wheels fastened beneath the base, where the set of wheels enable the shopping cart with passenger seating to easily move from one place to another.

2. The shopping cart with passenger seating according to claim 1, wherein the child seat includes a backing to support a back of the child.

3. The shopping cart with passenger seating according to claim 1, wherein the chair support includes a seat cushion.

4. The shopping cart with passenger seating according to claim 3, wherein the body includes a back cushion, where the seat cushion and the back cushion provide padding for the seated user.

5. The shopping cart with passenger seating according to claim 1, wherein the pair of armrests are padded.

6. The shopping cart with passenger seating according to claim 1, wherein at a front portion of the base is a footrest for the seated user.

7. The shopping cart with passenger seating according to claim 1, wherein the storage surface accepts more than one container.

8. The shopping cart with passenger seating according to claim 1, wherein the container is one of at least a basket, a box or a mesh bag.
